(19) United States
(12) Patent Application Publication
(10) Pub. No.: US 2022/0035731 A1
(43) Pub. Date: Feb. 3, 2022

(54) TEST METHOD BASED ON IMPROVED REST PROTOCOLS AND ELECTRONIC DEVICE

(71) Applicant: HON HAI PRECISION INDUSTRY CO., LTD., New Taipei (TW)

(72) Inventor: CHIEN-WU YEN, New Taipei (TW)

(21) Appl. No.: 17/387,958

(22) Filed: Jul. 28, 2021

(30) Foreign Application Priority Data
Jul. 29, 2020 (CN) 202010746418.2

(51) Int. Cl. G06F 11/36; G06F 11/07; H04L 29/06; H04L 29/08

(52) U.S. Cl. CPC G06F 11/3688; G06F 11/3692; H04L 67/02; H04L 67/40; G06F 11/0772

(57) ABSTRACT

A test method based on improved REST protocols and an electronic device applying the method are disclosed. In response to a received test task, the method sends a REST control request in JSON format from the client to the server and receives a REST response fed back by the server according to the REST control request. A status code is obtained from the REST response and response mode is determined according to the status code, thereby testing the client and the server based on the improved REST protocol. The REST protocol is easy to upgrade, supports multiple protocols, and reduces the complexity of the system, the data is simple and flexible.

### FIELD

The present disclosure relates to a technical field of testing, specifically a test method based on improved REST protocols and an electronic device.

### BACKGROUND

Remote Procedure Call Protocol (RPC protocol) is usually used for testing between a client and a server.

However, in the test using RPC protocol, the system and programming language are complex, the upgrade cost is high, and it is not easy to debug. The server cannot send information to the client initially, and it is not easy to trace back when an error occurs. For example, in a timeout state, maybe the server is getting the request, but there is no response due to execution failure. Or it may be that the request is lost due to network errors or other failures. The client cannot directly determine the cause of the error. At this time, the client needs to retry again and again for each RPC timeout, not only leading to redundant code, but also a reduction in test performance.

### SUMMARY

A test method based on improved REST protocols and an electronic device is disclosed. Tests between clients and servers based on improved REST protocols are realized, a system is easily upgraded, and multiple protocols are supported. The complexity of the system is reduced, and the data is simple and flexible and not easy to make mistakes.

The test method based on improved REST protocols is applied to a client communicating with a server and includes: sending a REST control request in JSON format to the server, in response to a received test task; receiving a REST response fed back by the server according to the REST control request; obtaining status codes from the REST response and determining response modes according to the status codes.

In some embodiments, the REST control request and the REST response are compiled in C language, C++, or Python language.

In some embodiments, the method of determining response modes according to the status codes includes: determining a first character of the status codes; determining a response status corresponding to the first character; detecting an error type of the test task, when the response status is a client error or a server error; sending the REST control request in JSON format to the server.

In some embodiments, the method of detecting the error type of the test task includes: acquiring a pre-configured HTTP status code list, the HTTP status code list storing a correspondence between codes and error types; matching the status code with codes in the HTTP status code list; determining an error type corresponding to the matched code as the error type of the test task.

In some embodiments, obtaining standardized HTTP status codes and corresponding error types is further included. Customized status codes and specified error types are obtained and configuring the HTTP status code list according to the obtained status codes and corresponding error types.

In some embodiments, stopping the test task is included in response to a convergence of the REST response.

A method of testing based on improved REST protocols is applied to a server communicating with a client, the method includes: in response to a REST control request in JSON format being sent by the client, obtaining a call identifier from the REST control request; matching a server code corresponding to the call identifier, and executing the server code to obtain a status code and result. The status code and the result are taken as a REST response and feeding back the REST response to the client.

A test device based on improved REST protocols, run on a client communicating with a server is also disclosed, the device includes: a sending module configured to send a REST control request in JSON format to the server, in response to a received test task; a receiving module configured to receive a REST response fed back by the server according to the REST control request; a response module configured to obtain status codes from the REST response and determine response modes according to the status codes.

In some embodiments, the REST control request and the REST response are compiled in C, C++, or Python language.

In some embodiments, the response module is specifically configured to: determine a first character of the status codes; determine a response status corresponding to the first character; detect an error type of the test task, when the response status is a client error or a server error; send the REST control request in JSON format to the server.

In some embodiments, the response module detecting the error type of the test task includes: acquiring a pre-configured HTTP status code list, the HTTP status code list storing a correspondence between codes and error types; matching the status code with codes in the HTTP status code list; determining an error type corresponding to the matched code as the error type of the test task.

In some embodiments, the device further includes: an acquisition of standardized HTTP status codes and corresponding error types; the acquisition module is further configured to obtain customized status codes and specified error types; a configuration module configuring the HTTP status code list according to the obtained status codes and corresponding error types.

In some embodiments, the device further includes: a testing module configured to stop the test task, in response to a convergence of the REST response.

A test device based on improved REST protocols is run on a server communicating with a client and includes: an acquisition module configured to obtain a call identifier from the REST control request in response to a REST control request in JSON format being sent by the client; an execution module configured to match a server code corresponding to the call identifier, and execute the server code to obtain a status code and result; a feedback module configured to take the status code and the result data as a REST response and feedback the REST response to the client.

In some embodiments, the REST control request and the REST response are compiled in C, C++, or Python language.

In some embodiments, the processor determining response modes according to the status codes includes: determine a first character of the status codes; determine a response status corresponding to the first character; detect an error type of the test task, when the response status is a client error or a server error; send the REST control request in JSON format to the server.

In some embodiments, the processor to detect the error type of the test task includes: acquire a pre-configured HTTP status code list, the HTTP status code list storing a correspondence between codes and error types; match the status code with codes in the HTTP status code list; determine an error type corresponding to the matched code as the error type of the test task.

In some embodiments, the processor further obtains standardized HTTP status codes and corresponding error types; obtains customized status codes and specified error types; configures the HTTP status code list according to the obtained status codes and corresponding error types.

In some embodiments, the processor further stops the test task, in response to a convergence of the REST response.

A server includes a memory and a processor, the memory stores at least one computer-readable instruction, and the processor executes the at least one computer-readable instruction to implement the following: in response to a REST control request in JSON format being sent by the client, obtain a call identifier from the REST control request; match a server code corresponding to the call identifier, and execute the server code to obtain a status code and result; take the status code and the result data as a REST response and feedback the REST response to the client.

A client includes a memory and a processor, the memory stores at least one computer-readable instruction, and the processor executes the at least one computer-readable instruction to implement to a test method based on improved REST protocols.

A server includes a memory and a processor, the memory stores at least one computer-readable instruction, and the processor executes the at least one computer-readable instruction to implement to a test method based on improved REST protocols.

A non-transitory storage medium having stored thereon at least one computer-readable instruction that, when executed by a processor, implements a test method based on improved REST protocols.

### BRIEF DESCRIPTION OF THE DRAWINGS

FIG. 1 shows a flowchart of a test method based on improved REST protocols provided in an embodiment of the present disclosure.

FIG. 2 shows a flowchart of a test method based on improved REST protocols provided in another embodiment of the present disclosure.

FIG. 3 shows a schematic structural diagram of a test device based on improved REST protocols provided in an embodiment of the present disclosure.

FIG. 4 shows a schematic structural diagram of a test device based on improved REST protocols provided in another embodiment of the present disclosure.

FIG. 5 shows a schematic structural diagram of a client to implement a test method based on improved REST protocols provided in an embodiment of the present disclosure.

FIG. 6 shows a schematic structural diagram of a server to implement a test method based on improved REST protocols provided in an embodiment of the present disclosure.

### DETAILED DESCRIPTION

The drawings combined with the detailed description illustrate the embodiments of the present disclosure hereinafter. It is noted that embodiments of the present disclosure and features of the embodiments can be combined, when there is no conflict.

Various details are described in the following descriptions for a better understanding of the present disclosure, however, the present disclosure may also be implemented in other ways other than those described herein. The scope of the present disclosure is not to be limited by the specific embodiments disclosed below.

Unless defined otherwise, all technical and scientific terms used herein have the same meaning as commonly understood by one of ordinary skill in the art to which the present disclosure belongs. The terms used in the present disclosure are only for the purpose of describing specific embodiments and are not intended to limit the present disclosure.

In some embodiments, the test method based on improved REST protocols of the present disclosure is applied to one or more electronic devices. The electronic device includes hardware such as, but not limited to, a microprocessor and an Application Specific Integrated Circuit (ASIC), Field-Programmable Gate Array (FPGA), Digital Signal Processor (DSP), embedded devices, etc.

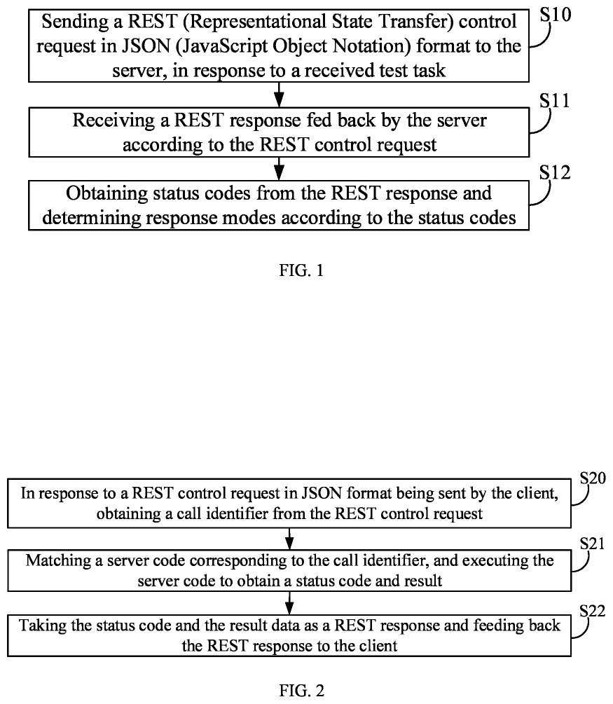

FIG. 1 is a flowchart of a test method based on improved REST protocols in an embodiment of the present disclosure. According to different needs, the order of the steps in the flowchart can be changed, and some can be omitted.

The test method based on the improved REST protocols is applied to one or more clients, the client is a device that can automatically perform numerical calculation and/or information processing in accordance with pre-set or stored instructions. Its hardware includes but is not limited to microprocessors, Application Specific Integrated Circuits (ASIC), Field-Programmable Gate Array (FPGA), Digital Signal Processors (DSP), embedded devices, etc.

The client can be any electronic product that can interact with the user equipment, for example, a personal computer, a tablet computer, a smart phone, a personal digital assistant (PDA), a game console, an interactive network television (Internet Protocol Television, IPTV), smart wearable devices, etc.

The client may also include network equipment and/or user equipment. Wherein, the network device includes but is not limited to a single network server, a server group composed of multiple network servers, or a cloud composed of a large number of hosts or network servers based on Cloud Computing.

The network where the client is located includes, but is not limited to, the Internet, a wide area network, a metropolitan area network, a local area network, a virtual private network (VPN), etc.

In one embodiment, the client communicates with a server.

In block S10, sending a REST (Representational State Transfer) control request in JSON (JavaScript Object Notation) format to the server, in response to a received test task.

In the traditional REST protocols, control requests are based on a text format, which belong to an implicit data type conversion, and error rates are high.

Therefore, the REST control request in the present disclosure uses the JSON format, such as RFC 7159. Since data is checked before the data is sent, the error rates are effectively reduced.

In some embodiments, a message of the control request includes a REST payload, a call identifier, and related data for executing the test task.

In addition, the REST payload, the call identifier, and the related data of the execution test task are all in JSON format.

In block S11, receiving a REST response fed back by the server according to the REST control request.

The REST control request and the REST response are compiled in C language, C++, or Python language.

Throughout the above embodiments, parameters between the client and the server are variable, and the flexibility is higher.

In block S12, obtaining status codes from the REST response and determining response modes according to the status codes.

In at least one embodiment of the present disclosure, the method of determining response modes according to the status codes includes: determining a first character of the status codes; determining a response status corresponding to the first character; detecting an error type of the test task, when the response status is a client error or a server error; sending the REST control request in JSON format to the server.

For example, according to a configuration, when the first character is digit 1, it means a message; when the first character is digit 2, it means success; when the first character is digit 3, it means redirection; when the first character is digit 4, it indicates a client error and when the first character is digit 5, it indicates a server error.

In the above, the message represents that the request has been accepted and needs to be processed further. This type of response is a temporary response, which only contains a status line and some optional response header information, and ends with a blank line. The responses represented by these status codes are all informational and indicate other actions that the user should take.

Success means that the request has been successfully received, understood, and accepted by the server.

Redirection means that the client needs to take further action to complete the request. Usually, these status codes are used for redirection.

Client error means that the client seems to have experienced an error, which hinders the server's processing.

Server error means that the server cannot complete an apparently valid request. This type of status codes represent an error or abnormal state occurring during the server's processing of the request. It may also represent that the server determines that current software and hardware resources cannot complete the processing of the request.

In some embodiments, the method of detecting the error type of the test task includes: acquiring a pre-configured HTTP status code list, the HTTP status code list storing a correspondence between codes and error types; matching the status code with codes in the HTTP status code list; and determining an error type corresponding to the matched code as the error type of the test task.

For example, “400” means a wrong request, “502” means a wrong gateway, etc.

Throughout the above embodiments, the error types can be directly determined, which facilitates locations and resolution of causes of the error as soon as possible, thereby improving the robustness of the system.

In at least one embodiment of the present disclosure, the method further includes: obtaining standardized HTTP status codes and corresponding error types; obtaining customized status codes and specified error types; configuring the HTTP status code list according to the obtained status codes and corresponding error types.

Throughout the above embodiments, the HTTP status code list is configured in combination with standardized HTTP status codes and customized status codes, so that coverage of data in the HTTP status code list is more comprehensive, sufficient to meet the testing requirements.

In at least one embodiment of the present disclosure, the test method based on the improved REST protocol further includes: stopping the test task, in response to a convergence of the REST response.

Throughout the above embodiments, the test can be stopped when the test result tends to converge, thereby avoiding any waste of time.

It can be seen from the above embodiments that, in response to a received test task, the present disclosure can send a REST control request in JSON format to the server, and receive a REST response fed back by the server according to the REST control request. Status codes from the REST response are then obtained and response modes are determined according to the status codes, so as to test the client and the server based on the improved REST protocol, which is easy to upgrade, supports multiple protocols, and reduces the complexity of the system. The data is simple and flexible and not easy to make mistakes.

FIG. 2 is a flowchart of a test method based on improved REST protocols in another embodiment of the present disclosure. According to different needs, the order of the steps in the flowchart can be changed, and some can be omitted.

The test method based on the improved REST protocols is applied to one or more servers, the server is a device that can automatically perform numerical calculation and/or information processing in accordance with pre-set or stored instructions. The server's hardware includes but is not limited to microprocessors, Application Specific Integrated Circuits (ASIC), Field-Programmable Gate Array (FPGA), Digital Signal Processors (DSP), embedded devices, etc.

The server can be any electronic product that can interact with the user equipment, for example, a personal computer, a tablet computer, a smart phone, a personal digital assistant (PDA), a game console, an interactive network television (Internet Protocol Television, IPTV), smart wearable devices, etc.

The server may also include network equipment and/or user equipment. Wherein, the network device includes but is not limited to a single network server, a server group composed of multiple network servers, or a cloud composed of a large number of hosts or network servers based on Cloud Computing.

The network where the server is located includes, but is not limited to, the Internet, a wide area network, a metropolitan area network, a local area network, a virtual private network (VPN), etc.

In one embodiment, the server communicates with a client.

In block S20, in response to a REST control request in JSON format being sent by the client, obtaining a call identifier from the REST control request.

In the traditional REST protocols, control requests are based on a text format, which belong to an implicit data type conversion, and error rates are high.

Therefore, the REST control request in the present disclosure uses the JSON format, such as RFC 7159. Data is checked before the data is sent, thus the error rates are effectively reduced.

In some embodiments, a message of the control request includes a REST payload, a call identifier, and related data for executing the test task.

In addition, the REST payload, the call identifier, and the related data of the execution test task are all in JSON format.

In block S21, matching a server code corresponding to the call identifier, and executing the server code to obtain a status code and result.

In block S22, taking the status code and the result data as a REST response and feeding back the REST response to the client.

The REST control request and the REST response are compiled in C language, C++, or Python language.

Throughout the above embodiments, parameters between the client and the server are variable, and the flexibility is higher.

In response to a REST control request in JSON format being sent by the client, the present disclosure illustrates a call identifier from the REST control request being obtained, and matching a server code corresponding to the call identifier, then executing the server code to obtain a status code and result, and further taking the status code and the result as a REST response and feeding back the REST response to the client, so as to test the client and the server based on the improved REST protocol, which is easy to upgrade, supports multiple protocols, and reduces the complexity of the system. The data is flexible and not easily misused.

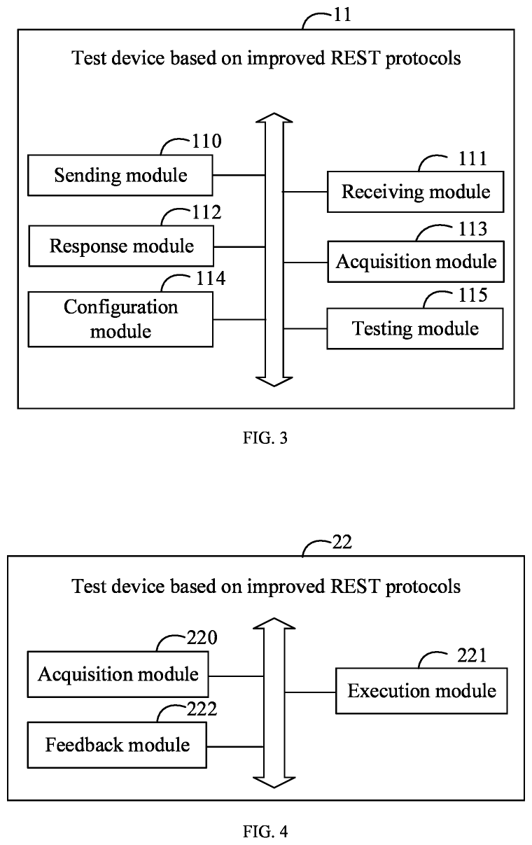

FIG. 3 shows a schematic structural diagram of a test device based on improved REST protocols in another embodiment of the present disclosure.

In some embodiments, the test device based on improved REST protocols 11 runs on a client. The test device based on improved REST protocols 11 can include a plurality of function modules consisting of program code segments. The program code of each program code segments in the test device based on improved REST protocols 11 can be stored in a memory and executed by at least one processor to perform a test method based on improved REST protocols (described in detail in FIG. 1).

As shown in FIG. 3, the test device based on improved REST protocols 11 can include: a sending module 110, a receiving module 111, a response module 112, an acquisition module 113, a configuration module 114, and a testing module 115. A module as referred to in the present disclosure refers to a series of computer-readable instruction segments that can be executed by at least one processor and that are capable of performing fixed functions, which are stored in a memory. The functions of each module will be detailed.

The above-mentioned integrated unit implemented in a form of software functional modules can be stored in a non-transitory readable storage medium. The above software function modules are stored in a storage medium and include several instructions for causing a client (which can be a personal computer, a dual-screen device, or a network device) or a processor to execute the method described in various embodiments in the present disclosure.

The sending module 110 sends a REST (Representational State Transfer) control request in JSON (JavaScript Object Notation) format to the server, in response to a received test task.

In the traditional REST protocols, control requests are based on a text format, which belong to an implicit data type conversion, and error rates are high.

Therefore, the REST control request in the present disclosure uses the JSON format, such as RFC 7159. Since data is checked before the data is sent, the error rates are effectively reduced.

In some embodiments, a message of the control request includes a REST payload, a call identifier, and related data for executing the test task.

In addition, the REST payload, the call identifier, and the related data of the execution test task are all in JSON format.

The receiving module 111 receives a REST response fed back by the server according to the REST control request.

The REST control request and the REST response are compiled in C language, C++, or Python language.

Throughout the above embodiments, parameters between the client and the server are variable, and the flexibility is higher.

The response module 112 obtains status codes from the REST response and determines response modes according to the status codes.

In at least one embodiment of the present disclosure, the response module 112 determining response modes according to the status codes includes: determining a first character of the status codes; determining a response status corresponding to the first character; detecting an error type of the test task, when the response status is a client error or a server error; sending the REST control request in JSON format to the server.

For example, according to a configuration, when the first character is digit 1, it means a message; when the first character is digit 2, it means success; when the first character is digit 3, it means redirection; when the first character is digit 4, it indicates a client error and when the first character is digit 5, it indicates a server error.

In the above, the message represents that the request has been accepted and needs to be processed further. This type of response is a temporary response, which only contains a status line and some optional response header information, and ends with a blank line. The responses represented by these status codes are all informational and indicate other actions that the user should take.

Success means that the request has been successfully received, understood, and accepted by the server.

Redirection means that the client needs to take further action to complete the request. Usually, these status codes are used for redirection.

Client error means that the client seems to have experienced an error, which hinders the server's processing.

Server error means that the server cannot complete an apparently valid request. This type of status codes represents an error or abnormal state occurring during the server's processing of the request. It may also represent that the server determines that current software and hardware resources cannot complete the processing of the request.

In some embodiments, the response module 112 detecting the error type of the test task includes: acquiring a pre-configured HTTP status code list, the HTTP status code list storing a correspondence between codes and error types; matching the status code with codes in the HTTP status code list; and determining an error type corresponding to the matched code as the error type of the test task.

For example, “400” means a wrong request, “502” means a wrong gateway, etc.

Throughout the above embodiments, the error types can be directly determined, which facilitates location and resolution of causes of the error as soon as possible, thereby improving the robustness of the system.

In at least one embodiment of the present disclosure, the acquisition module 113 obtains standardized HTTP status codes and corresponding error types; obtains customized status codes and specified error types.

The configuration module 114 configures the HTTP status code list according to the obtained status codes and corresponding error types.

Throughout the above embodiments, the HTTP status code list is configured in combination with standardized HTTP status codes and customized status codes, so that a coverage of data in the HTTP status code list is more comprehensive, sufficient to meet the testing requirements.

In at least one embodiment of the present disclosure, the testing module 115 stops the test task when there is a convergence of the REST response.

Throughout the above embodiments, the test can be stopped when the test result tends to converge, thereby avoiding any waste of time.

It can be seen from the above embodiments that, in response to a received test task, the present disclosure can send a REST control request in JSON format to the server, and receive a REST response fed back by the server according to the REST control request. Then obtaining status codes from the REST response and determining response modes according to the status codes, so as to realize a test between the client and the server based on the improved REST protocol, which is easy to upgrade, supports multiple protocols, and reduces the complexity of the system. The data is flexible and not easy to make mistakes.

FIG. 4 shows a schematic structural diagram of a test device based on improved REST protocols in another embodiment of the present disclosure.

In some embodiments, the test device based on improved REST protocols 22 runs on a client. The test device based on improved REST protocols 22 can include a plurality of function modules consisting of program code segments. The program code of each program code segments in the test device based on improved REST protocols 22 can be stored in a memory and executed by at least one processor to perform a test method based on improved REST protocols (described in detail in FIG. 2).

As shown in FIG. 4, the test device based on improved REST protocols 22 can include: an acquisition module 220, an execution module 221, and a feedback module 222. A module as referred to in the present disclosure refers to one of a series of computer-readable instruction segments that can be executed by at least one processor and that are capable of performing fixed functions, which are stored in a memory.

The above-mentioned integrated unit implemented in a form of software functional modules can be stored in a non-transitory readable storage medium. The above software function modules are stored in a storage medium and include several instructions for causing a server (which can be a personal computer, a dual-screen device, or a network device) or a processor to execute the method described in various embodiments in the present disclosure.

The acquisition module 220, in response to a REST control request in JSON format being sent by the client, obtains a call identifier from the REST control request.

In the traditional REST protocols, control requests are based on a text format, which belong to an implicit data type conversion, and error rates are high.

Therefore, the REST control request in the present disclosure uses the JSON format, such as RFC 7159. Since data is checked before the data is sent, the error rates are effectively reduced.

In some embodiments, a message of the control request includes a REST payload, a call identifier, and related data for executing the test task.

In addition, the REST payload, the call identifier, and the related data of the execution test task are all in JSON format.

The execution module 221 matches a server code corresponding to the call identifier and executes the server code to obtain a status code and result.

The feedback module 222 takes the status code and the result as a REST response and feeds the REST response back to the client.

The REST control request and the REST response are compiled in C language, C++, or Python language.

Throughout the above embodiments, parameters between the client and the server are variable, and the flexibility is higher.

In response to a REST control request in JSON format being sent by the client, a call identifier is obtained from the REST control request, and a server code corresponding to the call identifier is matched, then the server code is executed to obtain a status code and result, and the status code and the result are taken as a REST response, feeding back the REST response to the client, so as to realize a test between the client and the server based on the improved REST protocol, which is easy to upgrade, supports multiple protocols, and reduces the complexity of the system. The data is flexible and not easy to make mistakes.

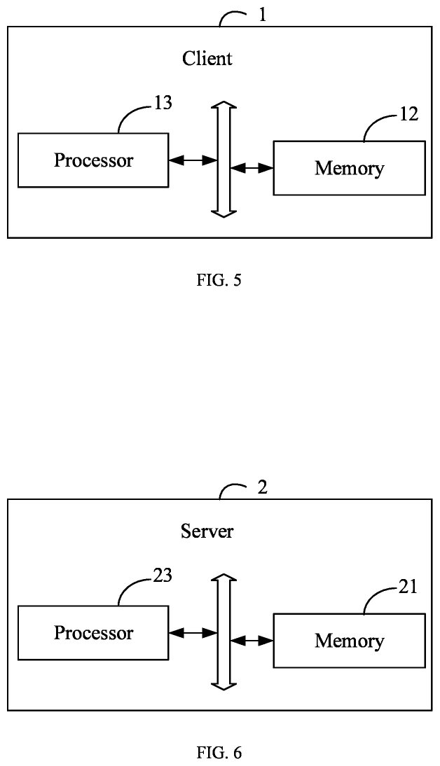

FIG. 5 is a schematic structural diagram of a client provided in an embodiment of the present disclosure. The client 1 may include: a memory 12, at least one processor 13, and computer-readable instructions stored in the memory 12 and executable on the at least one processor 13. The processor 13 executes the computer-readable instructions to implement the steps in the embodiment of the test method based on improved REST protocols, such as in steps in block S10-S12 shown in FIG. 1. Alternatively, the processor 13 executes the computer-readable instructions to implement the functions of the modules/units in the foregoing device embodiments, such as the modules 110-115 in FIG. 3.

For example, the computer-readable instructions can be divided into one or more modules/units, and the one or more modules/units are stored in the memory 12 and executed by the at least one processor 13. The one or more modules/units can be a series of computer-readable instruction segments capable of performing specific functions, and the instruction segments are used to describe execution processes of the computer-readable instructions in the client 1. For example, the computer-readable instructions can be divided into the sending module 110, a receiving module 111, a response module 112, an acquisition module 113, a configuration module 114, and a testing module 115 as in FIG. 3.

The client 1 can be a desktop computer, a notebook, a palmtop computer, or a cloud server. Those skilled in the art will understand that the schematic diagram 3 is only an example of the client 1 and does not constitute a limitation on the client 1. Another client 1 may include more or fewer components than shown in the figures or may combine some components or have different components. For example, the client 1 may further include an input/output device, a network access device, a bus, and the like.

The at least one processor 13 can be a central processing unit (CPU), or can be another general-purpose processor, digital signal processor (DSPs), application-specific integrated circuit (ASIC), Field-Programmable Gate Array (FPGA), another programmable logic device, discrete gate, transistor logic device, or discrete hardware component, etc. The processor 13 can be a microprocessor or any conventional processor. The processor 13 is a control center of the client 1 and connects various parts of the entire client 1 by using various interfaces and lines.

The memory 12 can be configured to store the computer-readable instructions and/or modules/units. The processor 13 may run or execute the computer-readable instructions and/or modules/units stored in the memory 12 and may call up data stored in the memory 12 to implement various functions of the client 1. The memory 12 mainly includes a storage program area and a storage data area. The storage program area may store an operating system, and an application program required for at least one function (such as a sound playback function, an image playback function, etc.), etc. The storage data area may store data (such as audio data, phone book data, etc.) created according to the use of the client 1. In addition, the memory 12 may include a random access memory, and may also include a non-transitory storage medium, such as a hard disk, an internal memory, a plug-in hard disk, a smart media card (SMC), a secure digital (SD) Card, a flashcard, at least one disk storage device, a flash memory device, or another non-transitory solid-state storage device.

When the modules/units integrated into the client 1 are implemented in the form of software functional units having been sold or used as independent products, they can be stored in a non-transitory readable storage medium. Based on this understanding, all or part of the processes in the methods of the above embodiments implemented by the present disclosure can also be completed by related hardware instructed by computer-readable instructions. The computer-readable instructions can be stored in a non-transitory readable storage medium. The computer-readable instructions, when executed by the processor, may implement the steps of the foregoing method embodiments. The computer-readable instructions include computer-readable instruction codes, and the computer-readable instruction codes can be in a source code form, an object code form, an executable file, or some intermediate form. The non-transitory readable storage medium can include any entity or device capable of keeping the computer-readable instruction code, such as a recording medium, a U disk, a mobile hard disk, a magnetic disk, an optical disk, a computer memory, or a read-only memory (ROM).

FIG. 6 is a schematic structural diagram of a server provided in embodiment of the present disclosure. The server 2 may include: a memory 21, at least one processor 23, and computer-readable instructions stored in the memory 21 and executable on the at least one processor 23, for example, image recognition programs. The processor 23 executes the computer-readable instructions to implement the steps in the embodiment of the test method based on improved REST protocols, such as in steps in block S20-S22 shown in FIG. 2. Alternatively, the processor 23 executes the computer-readable instructions to implement the functions of the modules/units in the foregoing device embodiments, such as the modules 220-222 in FIG. 4.

Exemplarily, the computer-readable instructions can be divided into one or more modules/units, and the one or more modules/units are stored in the memory 21 and executed by the at least one processor 23. The one or more modules/units can be a series of computer-readable instruction segments capable of performing specific functions, and the instruction segments are used to describe execution processes of the computer-readable instructions in the server 2. For example, the computer-readable instruction can be divided into the acquisition module 220, the execution module 221, and the feedback module 222 as in FIG. 4.

In the several embodiments provided in the present application, it should be understood that the disclosed electronic device and method can be implemented in other ways. For example, the embodiments of the devices described above are merely illustrative. For example, divisions of the units are only logical function divisions, and there can be other manners of division in actual implementation.

In addition, each functional unit in each embodiment of the present disclosure can be integrated into one processing unit or can be physically present separately in each unit or two or more units can be integrated into one unit. The above modules can be implemented in a form of hardware or in a form of a software functional unit.

The present disclosure is not limited to the details of the above-described exemplary embodiments, and the present disclosure can be embodied in other specific forms without departing from the spirit or essential characteristics of the present disclosure. Therefore, the present embodiments are to be considered as illustrative and not restrictive, and the scope of the present disclosure is defined by the appended claims. All changes and variations in the meaning and scope of equivalent elements are included in the present disclosure. Any reference sign in the claims should not be construed as limiting the claim. Furthermore, the word “includes” does not exclude other units nor does the singular exclude the plural. A plurality of units or devices stated in the system claims may also be implemented by one unit or device through software or hardware. Words such as “first” and “second” are used to indicate names, but not in any particular order.

Finally, the above embodiments are only used to illustrate technical solutions of the present disclosure and are not to be taken as restrictions on the technical solutions. Although the present disclosure has been described in detail with reference to the above embodiments, those skilled in the art should understand that the technical solutions described in one embodiment can be modified, or some of the technical features can be equivalently substituted, and that these modifications or substitutions are not to detract from the essence of the technical solutions or from the scope of the technical solutions of the embodiments of the present disclosure.

What is claimed is:

1. A test method based on improved REST protocols, applied to a client communicating with a server, the method comprising:
sending a REST control request in JSON format to the server, in response to a received test task;
receiving a REST response fed back by the server according to the REST control request;
obtaining status codes from the REST response and determining response modes according to the status codes.

2. The test method based on improved REST protocols according to claim 1, wherein the REST control request and the REST response are compiled in C language, C++, or Python language.

3. The test method based on improved REST protocols according to claim 1, wherein determining response modes according to the status codes comprises:
determining a first character of the status codes;
determining a response status corresponding to the first character;
detecting an error type of the test task, when the response status is a client error or a server error;
sending the REST control request in JSON format to the server.

4. The test method based on improved REST protocols according to claim 3, wherein detecting the error type of the test task comprises:
acquiring a pre-configured HTTP status code list, the HTTP status code list storing a correspondence between codes and error types;
matching the status code with codes in the HTTP status code list;
determining an error type corresponding to the matched code as the error type of the test task.

5. The test method based on improved REST protocols according to claim 4, further comprising:
obtaining standardized HTTP status codes and corresponding error types;
obtaining customized status codes and specified error types;
configuring the HTTP status code list according to the obtained status codes and corresponding error types.

6. The test method based on improved REST protocols according to claim 1, further comprising:
stopping the test task, in response to a convergence of the REST response.

7. An electronic device comprising a memory and a processor, the memory stores at least one computer-readable instruction, and the processor executes the at least one computer-readable instruction to:
send a REST control request in JSON format to the server, in response to a received test task;
receive a REST response fed back by the server according to the REST control request;
obtain status codes from the REST response and determining response modes according to the status codes.

8. The electronic device according to claim 7, wherein the REST control request and the REST response are compiled in C language, C++, or Python language.

9. The electronic device according to claim 7, wherein the processor determines response modes according to the status codes by:
determine a first character of the status codes;
determine a response status corresponding to the first character;
detect an error type of the test task, when the response status is a client error or a server error;
send the REST control request in JSON format to the server.

10. The electronic device according to claim 9, wherein the processor detects the error type of the test task by:
acquire a pre-configured HTTP status code list, the HTTP status code list storing a correspondence between codes and error types;
match the status code with codes in the HTTP status code list;
determine an error type corresponding to the matched code as the error type of the test task.

11. The electronic device according to claim 10, wherein the processor is further caused to:
obtain standardized HTTP status codes and corresponding error types;
obtain customized status codes and specified error types;
configure the HTTP status code list according to the obtained status codes and corresponding error types.

12. The electronic device according to claim 7, wherein the processor is further caused to:
stop the test task, in response to a convergence of the REST response.

13. The electronic device according to claim 7, wherein the processor is further caused to:
in response to a REST control request in JSON format being sent by the client, obtain a call identifier from the REST control request;
match a server code corresponding to the call identifier, and execute the server code to obtain a status code and result;
take the status code and the result data as a REST response and feedback the REST response to the client.

14. A non-transitory storage medium having stored thereon at least one computer-readable instructions that, when the at least one computer-readable instructions are executed by a processor to implement the following steps:
sending a REST control request in JSON format to the server, in response to a received test task;
receiving a REST response fed back by the server according to the REST control request;
obtaining status codes from the REST response and determining response modes according to the status codes.

15. The non-transitory storage medium according to claim 14, wherein the REST control request and the REST response are compiled in C language, C++, or Python language.

16. The non-transitory storage medium according to claim 14, wherein determining response modes according to the status codes comprises:
determining a first character of the status codes;
determining a response status corresponding to the first character;
detecting an error type of the test task, when the response status is a client error or a server error;
sending the REST control request in JSON format to the server.

17. The non-transitory storage medium according to claim 16, wherein detecting the error type of the test task comprises:
acquiring a pre-configured HTTP status code list, the HTTP status code list storing a correspondence between codes and error types;
matching the status code with codes in the HTTP status code list;
determining an error type corresponding to the matched code as the error type of the test task.

18. The non-transitory storage medium according to claim 17, further comprising:
obtaining standardized HTTP status codes and corresponding error types;
obtaining customized status codes and specified error types;
configuring the HTTP status code list according to the obtained status codes and corresponding error types.

19. The non-transitory storage medium according to claim 14, further comprising:
stopping the test task, in response to a convergence of the REST response.

20. The non-transitory storage medium according to claim 14, further comprising:
in response to a REST control request in JSON format being sent by the client, obtain a call identifier from the REST control request;
match a server code corresponding to the call identifier, and execute the server code to obtain a status code and result;
take the status code and the result data as a REST response and feedback the REST response to the client.
